(19) United States
(12) Patent Application Publication
(10) Pub. No.: US 2008/0028307 A1
(43) Pub. Date: Jan. 31, 2008

(54) IMAGE FORMING SYSTEM AND IMAGE FORMING METHOD

(75) Inventor: Ju-hyun OH, Anyang-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/779,508

(22) Filed: Jul. 18, 2007

(30) Foreign Application Priority Data
Jul. 28, 2006 (KR) 2006-71464

(51) Int. Cl. G06F 3/14

(52) U.S. Cl. 715/274

(57) ABSTRACT

An image forming system is disclosed. The image forming system comprises a URL acquiring part to acquire URL data corresponding to a location of a web page acquired through an Internet in a web browser; a URL format converting part to convert the URL data into at least one predetermined URL format data; and a print data generating part to convert the web page and the predetermined URL format data into print data to be outputted.

### CROSS-REFERENCE TO RELATED APPLICATIONS

This application claims the benefit of Korean Patent Application No. 2006-71464 filed on Jul. 28, 2006 in the Korean Intellectual Property Office, the disclosure of which is incorporated herein by reference.

### BACKGROUND OF THE INVENTION

1. Field of the Invention

Aspects of the present invention relate to an image forming system and an image forming method, and, more particularly, to an image forming system and an image forming method, which can print a concerned URL (Uniform Resource Locator) of a web page when printing a web page.

2. Description of the Related Art

As information communication apparatuses have developed, various kinds of mobile apparatuses, such as mobile phones, PDAs (Personal Digital Assistants), and network printers, as well as computers, include web browsers to access web pages on web servers. Web browsers support various types of services on the Internet. Accordingly, the web browser includes a (location identifying) method to identify a location of each server to acquire necessary information from servers providing various services. A URL (Uniform Resource Locator) is an address of a web page, i.e., a file on the server providing various services. The URL may include a type of service to be acquired therefrom, a location of server (domain name), a location of file, and the like.

Generally, when a web page is printed through a web browser, if a user clicks on a page setting menu item in a web browser menu, a page settings screen is displayed. Related URL data may be printed in a header or a footer of the web page. However, the URL data printed in the header or the footer of the web page has the same size font as a body of the web page. Further, if the URL data has a long address, some end part of the long address of the URL data is not printed. Thus, the user cannot check the full-length address of the URL data later.

### SUMMARY OF THE INVENTION

Accordingly, aspects of the present invention provide an image forming system and an image forming method, which can print a full address of concerned URL data when printing a web page.

Additional aspects and/or advantages of the present invention will be set forth in part in the description which follows and, in part, will be obvious from the description, or may be learned by practice of the present invention.

The foregoing and/or other aspects of the present invention are achieved by providing an image forming system, comprising: a URL acquiring part to acquire URL data corresponding to a location of a web page acquired through an Internet in a web browser; a URL format converting part to convert the URL data into at least one URL format data that enables a user to obtain all of the URL data; and a print data generating part to convert the web page and the predetermined URL format data into print data to be outputted.

According to another aspect of the present invention, the URL format converting part converts the URL data having a predetermined font size or a predetermined interval into the URL format data having a smaller font size than the predetermined font size or a narrower interval than the predetermined interval.

According to another aspect of the present invention, the URL format data comprises the URL format data that are printed separately one portion of the URL data printed in an upper area and the remainder of the URL data printed in a lower area.

According to another aspect of the present invention, the URL format data comprises the URL format data printed with the URL data in a lengthwise direction of a print medium.

According to another aspect of the present invention, the URL format data comprises the URL format data that are printed with the URL data in a barcode format.

According to another aspect of the present invention, the image forming system further comprises a memory part, wherein the URL format converting part stores the URL data in the memory part and provides a reference number to the URL data, and uses the reference number as the URL format data.

According to another aspect of the present invention, the image forming system further comprises a display part; and a URL option processing part to display an option screen on the display part, wherein the option screen has format setting information related to converting the URL data into the URL format data.

According to another aspect of the present invention, the image forming system further comprises an input part, and a preview generating part to generate preview URL format data depending on the selected one of the format setting information and to display the preview URL format data on the display part if a user selects, through the input part, a print preview function provided in the option screen and at least one of the format setting information displayed on the display part.

The foregoing and/or other aspects of the present invention are also achieved by providing an image forming method, comprising: acquiring URL data corresponding to a location of a web page acquired through Internet in a web browser; converting the URL data into at least one URL format data that enables a user to obtain all of the URL data; and outputting print data converted from the web page and the predetermined URL format data.

According to another aspect of the present invention, the image forming method further comprises displaying an option screen having format setting information related to converting the URL data into the URL format data.

According to another aspect of the present invention, if one of the respective format setting information of the option screen displayed on the display part is selected, the converting of the URL data into the URL format data comprises converting the URL data to the URL format data depending on the selected format setting information.

According to another aspect of the present invention, if the selected format setting information is related to adjusting a font size or an interval, the converting of the URL data into the URL format data further comprises converting the URL data having a predetermined font size or a predetermined interval into URL format data having a smaller font size than the predetermined font size or a narrower interval than the predetermined interval.

According to another aspect of the present invention, if the selected format setting information is related to printing in at least two lines, the converting of the URL data into the URL format data further comprises converting the URL data into the URL format data printed with the URL data in at least two lines.

According to another aspect of the present invention, if the selected format setting information is related to printing separately in a upper area and a lower area, the converting the URL into the URL format data further comprises converting the URL data into the URL format data that is printed separately with one portion of the URL data printed in the upper area and the remainder of the URL data printed in the lower area.

According to another aspect of the present invention, if the selected format setting information is related to printing in a lengthwise direction, the converting of the URL data into the URL format data further comprises converting the URL data into the URL format data printed with the URL data in a lengthwise direction of a print medium.

According to another aspect of the present invention, the image forming method further comprises generating preview URL format data depending on the selected one of the format setting information and displaying the preview URL format data on the display part.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of the embodiments, taken in conjunction with the accompanying drawings of which:

FIG. 1 is a schematic diagram illustrating an image forming system according to an embodiment of the present invention connected to a web server through Internet;

FIG. 2 is a block diagram illustrating an image forming control apparatus according to an embodiment of to the present invention;

FIG. 3 is a block diagram illustrating a construction of a URL print driving part in FIG. 2;

FIG. 4 is a flowchart illustrating an image forming method according to an embodiment of the present invention; and

FIG. 5 is an example screen displayed by the image forming system and the image forming method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

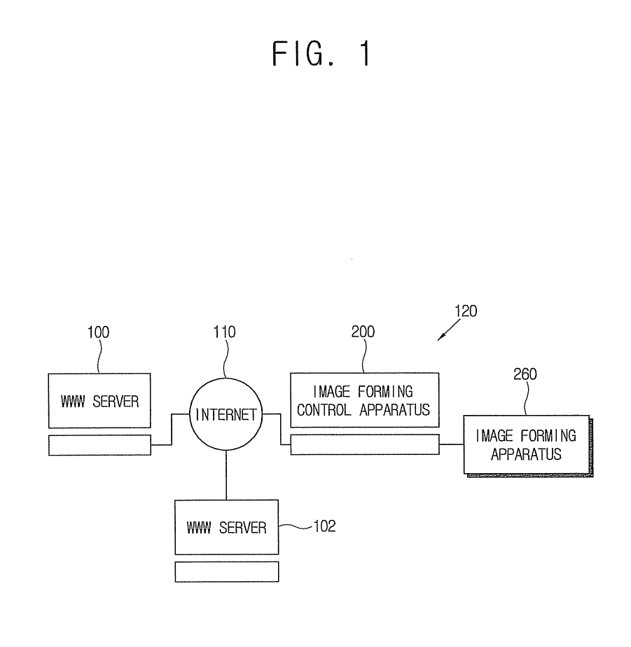

FIG. 1 is a schematic diagram illustrating an image forming system 120 connected to a web server through the Internet according to an embodiment of the present invention. FIG. 1 includes plural web servers 100 and 102 connected to each other through the Internet 110 and providing various types of services, and an image forming system 120 having a web browser capable of searching information in the plural web servers 100 and 102 through Internet 110. Here, the image forming system 120 includes an image forming control apparatus 200 and an image forming apparatus 260. The image forming control apparatus 200 may comprise a desktop personal computer, a laptop computer, or a mobile device. Alternatively, the image forming control apparatus 200 may be incorporated into the image forming apparatus 260.

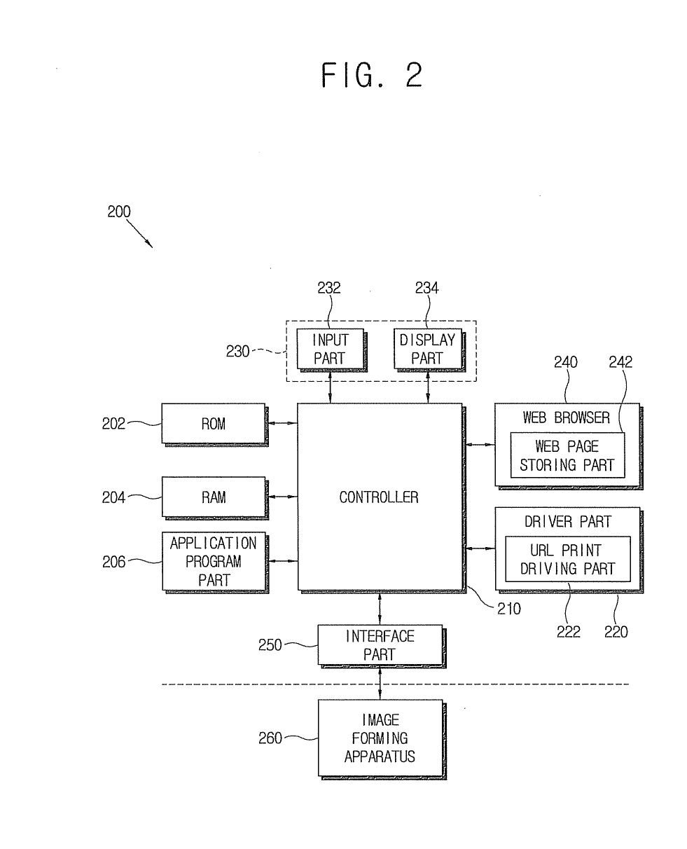

FIG. 2 is a block diagram illustrating a construction of the image forming system 120 according to an embodiment of the present invention. An image forming control apparatus 200 includes a ROM (Read Only Memory) 202, a RAM (Random Access Memory) 204, an application program part 206, a controller 210, a driver part 220, a user interface part 230, and a web browser 240.

The ROM 202 stores various kinds of control programs to perform functions of the image forming control apparatus 200. The RAM 204 stores programs, which are loaded from the ROM 202 and executed by the controller 210, or data processed by the controller 210. The controller 210 may include a Central Processing Unit (not shown). Further, the application program part 206 includes an application program through which a user may create various files.

A location identifying method identifies locations of servers providing various services from which necessary information can be acquired. A URL (Uniform Resource Locator) includes a type of service to be acquired therefrom, a location of server (domain name), a location of file, and other information related to accessing data.

The web browser 240, which includes a web page storing part 242, accesses web pages stored in the plural web servers 100 and 102 through the Internet 110 and downloads the accessed web pages. Then, the web browser 240 stores the downloaded web pages on the web page storing part 242. The web page includes text data, image data, audio/video data, or other data.

The driver part 220 stores setting information on a plurality of setting items related to forming an image, such as quantities, types, directions, and quality of printing. Other settings may be stored as well. Further, the driver 220 includes a URL driving part 222 to print a web page accessed through the Internet 110 in the web browser 240 and an address of the web page. The driver 220 also converts text data provided from the web page storing part 242 of the web browser 240, the setting information, and URL format data outputted from the URL print driving part 222 into print data that the image forming apparatus 260 can read.

The user interface part 230 interfaces a user and the image forming control apparatus 200 so that the user can change format setting information of the URL print driving part 222. The user interface part 230 may include an input part 232 and a display part 234. The input part 232 includes an input apparatus, such as a keyboard or a mouse to select or change the format setting information displayed on the display part 234. The display part 234 includes a display apparatus, such as a CRT (Cathode Ray tube) display or an LCD (Liquid Crystal Display), to display the format setting information of the URL print driving part 222. Other aspects of the invention may employ any input apparatus and any display apparatus.

The controller 210, which includes a CPU, a microcomputer, or the like, controls operations of the image forming control apparatus 200 by using various control programs stored in the ROM 202. An interface part 250 interfaces the image forming control apparatus 200 and an image forming apparatus 260 so that the image forming control apparatus 200 and the image forming apparatus 260 can communicate with each other. The interface part 250 is connected to the image forming control apparatus 200 and the image forming apparatus 260, respectively, through a local connection by using a USB (Universal Serial Bus) port, Firewire (IEEE 1394) port, or an LPT (Line Printer Terminal), or a network connection by using an IP sharer. The image forming control apparatus 200 may be connected to the image forming apparatus 260 in any fashion.

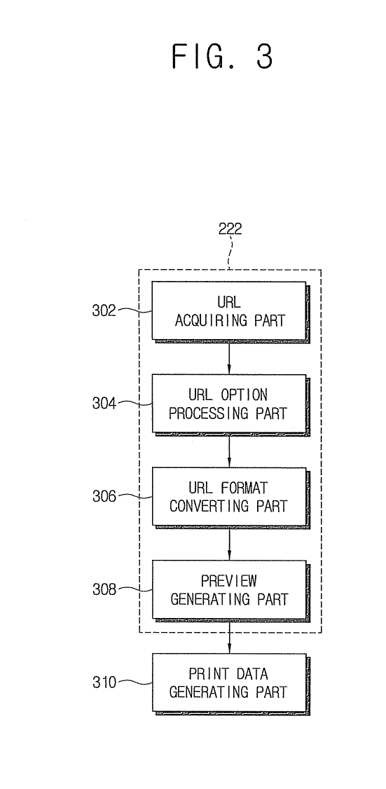

FIG. 3 is a block diagram illustrating in detail the URL print driving part 222 shown in FIG. 2. The URL print driving part 222 includes a URL acquiring part 302, a URL option processing part 304, a URL format converting part 306, and a preview generating part 308.

The URL acquiring part 302 acquires URL data corresponding to an address of a web page accessed through the Internet in the web browser. The URL acquiring part 302 acquires the URL data by direct user input through the input part 232 or by a user selection on the web page. The URL option processing part 304 displays a URL print option screen having each format setting information related to converting into URL format data on the display part 234 to interface with a user. If the user selects format setting information through the URL print option screen, the URL option processing part 304 stores the selected format setting information.

The URL format converting part 306 converts URL data to at least one predetermined URL format data. For example, the URL format converting part 306 may convert URL data having a predetermined font size or a predetermined interval into URL format data having a smaller font size than the predetermined font size or a narrower interval than the predetermined interval. The URL format converting part 306 may convert URL data into URL format data printed in at least two lines, URL format data that is printed with the URL data separately in an upper area and a lower area, URL format data printed with the URL data in a lengthwise direction, and/or URL format data printed with the URL data in a barcode format. Additionally, if the URL format converting part 306 stores URL data in a memory, the URL format converting part 306 may provide a reference number to the URL data so as to use the reference number as the corresponding URL format data to print the URL data. The preview generating part 308 generates URL format data depending on the format setting information that a user selects in the option processing part 304 and displays the generated URL format data on the display part 234.

The driver part 220 may further include a print data generating part 310. The print data generating part 310 converts web page and predetermined URL format data into print data and outputs the print data to the image forming apparatus 260.

As shown in FIG. 2, the URL print driving part 222 is provided in the image forming control apparatus 200. However, the URL print driving part 222 may be provided in the image forming apparatus 260. In this case, the image forming control apparatus 200 transmits additional information such as URL data to the image forming apparatus 260 by a user option having a standardized menu. Further, a URL print driving part (not shown) of the image forming apparatus 260 may then convert the URL data into URL format data depending on the user option.

In the case of a network printer capable of being connected to the server through the Internet, a web page accessed in the web browser and URL data corresponding to a location of the web page may be optionally processed and printed.

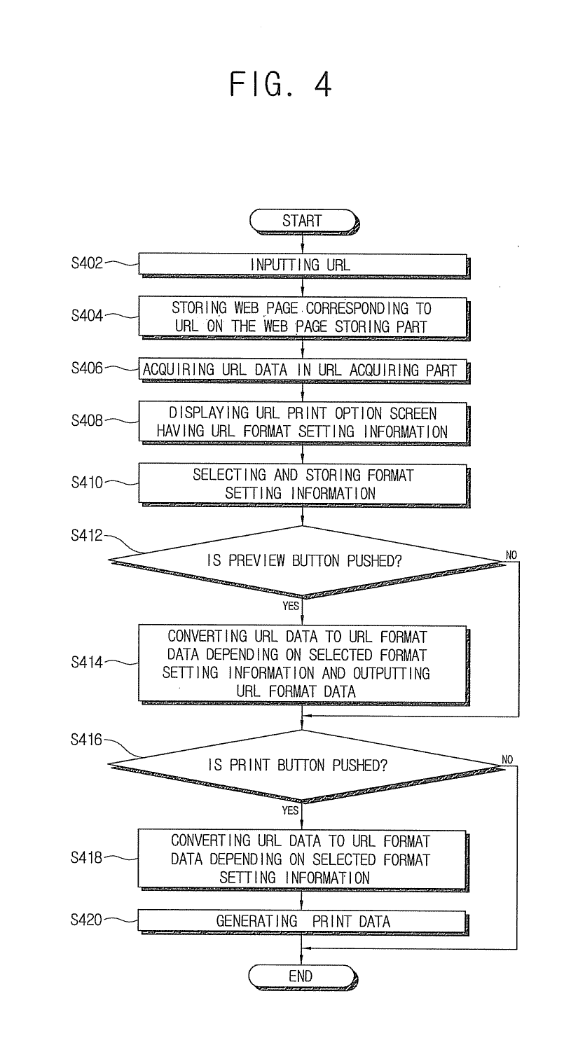

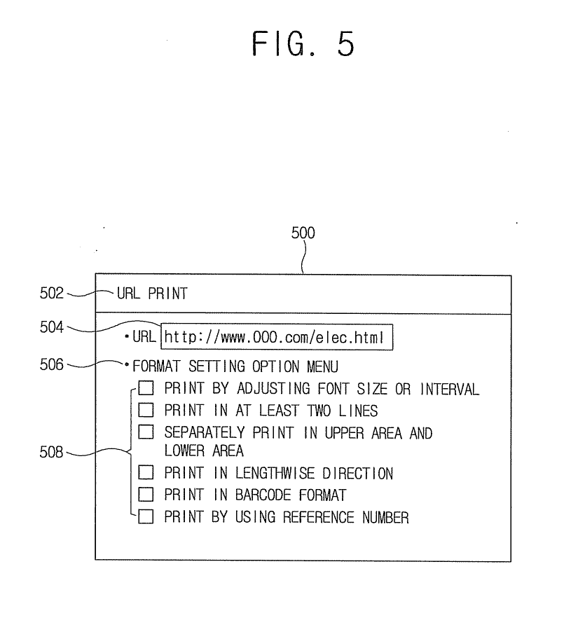

FIG. 4 is a flowchart illustrating an image forming method according an embodiment of to the present invention. FIG. 5 is a diagram illustrating an example screen displayed by the image forming system and the image forming method according to an embodiment of the present invention.

First, a user executes the web browser 240 to display a web browser screen on the display part 234. Then, if the user inputs a URL into the web browser screen through the input part 232 (S402), or selects a URL displayed on a web page, the web browser 240 searches for a server having a web page corresponding to the inputted or selected URL and accesses the corresponding web page in the server. Then, the web browser 240 stores the accessed web page and URL data corresponding to the accessed web page on the web page storing part 242 (S404) and displays the web page on the display part 234.

If the user pushes a print button to print the displayed web page on the display part 234 through the input part 232, the URL print driving part 222 provided in the driver part 220 of the image forming control apparatus 200 converts the web page and the URL data into print data that the image forming apparatus 260 can read. The URL acquiring part 302 acquires URL data by reading out the URL data stored in the web page storing part 242, where the web page is also stored (S406). Then, as shown in FIG. 5, the URL option processing part 304 displays a URL print option screen 500 on the display part 234 (S408). The URL print option screen 500 includes a first information display area 502 to display a title of the option screen, such as “URL print”, a URL data display area 504 to display URL data, a second information display area to display format setting option menu 506, and a format setting information display area to display format setting information that includes a plurality of format setting option menu items 508. The URL print option screen 500 may use any combination of these or other information display areas. The user selects and stores one of the format setting option menu items 508 (S410).

Then, if the user pushes a print button to print the displayed web page (S416), the URL format converting part 306 converts the URL data into URL format data depending on the format setting information selected by the user (S418). For example, if the user selects a first format setting option menu item to print the URL data that the URL acquiring part 302 has acquired by adjusting a predetermined font size or a predetermined interval of the URL data, the URL format converting part 306 adjusts the font size or the interval of the URL data to be smaller or narrower than the predetermined font size or the predetermined interval, respectively. If the user selects a second format setting option menu item to print the URL data in at least two lines, the URL format converting part 306 converts the URL data to URL format data printed with the URL data in at least two lines. If the user selects a third format setting option menu item to print the URL data separately in an upper area and a lower area, the URL format converting part 306 converts the URL data to URL format data that is printed separately with the URL data in the upper area and the lower area. If the user selects a fourth format setting option menu item to print the URL data in a lengthwise direction, the URL format converting part 306 converts the URL data to URL format data printed with the URL data in the lengthwise direction.

Then, the print data generating part 310 converts the converted URL format data and the web page data into print data and outputs the print data to the image forming apparatus 260 (S420). In addition to the above-described operations, if the user pushes a preview button to perform a preview function (S412), the preview generating part 308 generates URL format data depending on the format setting information, and displays the URL format data on the display part 234 (S414). Accordingly, the user can see how the URL format data will appear before printing the URL format data.

As is apparent from the above description, according to aspects of the present invention, a user can know the exact source of a web page by printing a full address of the web page.

Aspects of the invention can also be embodied as computer readable codes on a computer readable recording medium. Also, functional programs, codes, and code segments for accomplishing the present invention can be easily construed by programmers skilled in the art to which the present invention pertains. The computer readable recording medium may be any data storage device that can store data which can be thereafter read by a computer system. Examples of computer readable recording media include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion.

In addition, various components of the image forming system shown in FIG. 2 can be integrated into a single control unit, or alternatively, can be implemented in software or hardware, such as a field programmable gate array (FPGA) and an application specific integrated circuit (ASIC). As such, it is intended that the processes described herein, including those shown in FIG. 4, be broadly interpreted as being equivalently performed by software, hardware, or a combination thereof. Software modules can be written in a variety of software languages, including C, C++, Java, Visual Basic, and others.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming system, comprising:
a URL acquiring part to acquire URL data corresponding to a location of a web page acquired through an Internet in a web browser;
a URL format converting part to convert the URL data into at least one URL format data that enables a user to obtain all of the URL data; and
a print data generating part to convert the web page and the predetermined URL format data into print data to be outputted.

2. The image forming system according to claim 1, wherein the URL format converting part converts the URL data having a predetermined font size or a predetermined interval into the URL format data having a smaller font size than the predetermined font size or a narrower interval than the predetermined interval.

3. The image forming system according to claim 1, wherein the URL format data comprises URL format data printed with the URL data in at least two lines.

4. The image forming system according to claim 1, wherein the URL format data comprises URL format data printed separately with one portion of the URL data printed in an upper area and the remainder of the URL data printed in a lower area.

5. The image forming system according to claim 1, wherein the URL format data comprises URL format data printed with the URL data in a lengthwise direction of a print medium.

6. The image forming system according to claim 1, wherein the URL format data comprises URL format data printed with the URL data in a barcode format.

7. The image forming system according to claim 1, further comprising:
a memory part;
wherein the URL format converting part stores the URL data in the memory part and provides a reference number to the URL data, and uses the reference number as the URL format data.

8. The image forming system according to claim 1, further comprising:
a display part; and
a URL option processing part to display an option screen on the display part, wherein the option screen has format setting information related to converting the URL data into the URL format data.

9. The image forming system according to claim 8, further comprising:
an input part; and
a preview generating part to generate preview URL format data depending on a selected one of the format setting information and to display the preview URL format data on the display part if a user selects, through the input part, a print preview function provided in the option screen and at least one of the format setting information displayed on the display part.

10. An image forming method, comprising:
acquiring URL data corresponding to a location of a web page acquired through Internet in a web browser;
converting the URL data into at least one URL format data that enables a user to obtain all of the URL data; and
outputting print data converted from the web page and the predetermined URL format data.

11. The image forming method according to claim 10, further comprising displaying an option screen having format setting information related to converting the URL data into the URL format data.

12. The image forming method according to claim 11, wherein if one of the format setting information in the option screen displayed on a display part is selected, the converting the URL data into the URL format data comprises converting the URL data into URL format data depending on the selected format setting information.

13. The image forming method according to claim 12, wherein if the selected format setting information is related to adjusting a font size or an interval, the converting of the URL data into the URL format data further comprises converting the URL data having a predetermined font size or a predetermined interval into URL format data having a smaller font size than the predetermined font size or a narrower interval than the predetermined interval.

14. The image forming method according to claim 12, wherein if the selected format setting information is related to printing in at least two lines, the converting of the URL data into the URL format data further comprises converting the URL data into the URL format data printed with the URL data in at least two lines.

15. The image forming method according to claim 12, wherein if the selected format setting information is related to printing separately in an upper area and a lower area, the converting of the URL data into the URL format data further comprises converting the URL data into the URL format data that is printed separately with one portion of the URL data printed in the upper area and the remainder of the URL data printed in the lower area.

16. The image forming method according to claim 12, wherein if the selected format setting information is related to printing in a lengthwise direction, the converting of the URL data into the URL format data further comprises converting the URL data into the URL format data printed with the URL data in a lengthwise direction of a print medium.

17. The image forming method according to claim 12, further comprising:
generating preview URL format data depending on the format setting information selected; and
displaying the preview URL format data on the display part.

18. The image forming method according to claim 12, wherein if the selected format setting information is related to printing in a barcode format, the converting of the URL data into URL format data further comprises converting of the URL data into the URL format data printed with the URL data in a barcode format.

19. The image forming method according to claim 12, wherein if the selected format setting information is related to providing a reference numeral to URL data stored in a memory, the converting of the URL data into URL format data comprises using as the URL format data a reference number referencing the URL data stored in the memory.

20. A computer readable medium having stored thereon instructions which, when executed by a processor of an image forming apparatus, cause the image forming apparatus to perform the method of:
acquiring URL data corresponding to a location of a web page acquired through Internet in a web browser;
converting the URL data into at least one URL format data that enables a user to obtain all of the URL data; and
outputting print data converted from the web page and the URL format data.
